(19) United States
(12) Patent Application Publication
(10) Pub. No.: US 2023/0166456 A1
(43) Pub. Date: Jun. 1, 2023

(54) Three-Dimensional Shaping Device

(71) Applicant: SEIKO EPSON CORPORATION, Tokyo (JP)

(72) Inventor: Keitaro HASHIZUME, Shiojiri (JP)

(21) Appl. No.: 17/993,070

(22) Filed: Nov. 23, 2022

(30) Foreign Application Priority Data
Nov. 26, 2021 (JP) 2021-191797

(51) Int. Cl. B29C 64/393; B33Y 30/00; B33Y 50/02; B29C 64/295; B22F 12/17; B22F 10/85; B28B 1/00; B28B 17/00

(52) U.S. Cl. CPC B29C 64/393; B33Y 30/00; B33Y 50/02; B29C 64/295; B22F 12/17; B22F 10/85; B28B 1/001; B28B 17/0081

(57) ABSTRACT

A three-dimensional shaping device includes: a stage having a shaping surface on which a shaping material is to be stacked; a dispensing unit configured to dispense the shaping material toward a shaping region on the shaping surface; a position changing unit configured to change a relative position between the dispensing unit and the stage; a first heating unit configured such that a relative position between the first heating unit and the stage changes together with the dispensing unit, configured to cover the shaping region at a position facing the shaping surface when viewed along a stacking direction of the shaping material, and configured to heat the shaping material stacked in the shaping region; and a control unit configured to control the dispensing unit, the first heating unit, and the position changing unit to stack layers of the shaping material in the shaping region and to shape a three-dimensional shaped object. The control unit controls the first heating unit based on a facing distance indicating a distance between the stage and the first heating unit in the stacking direction when the three-dimensional shaped object is shaped.

The present application is based on, and claims priority from JP Application Serial Number 2021-191797, filed Nov. 26, 2021, the disclosure of which is hereby incorporated by reference herein in its entirety.

### BACKGROUND

### 1. Technical Field

The present disclosure relates to a three-dimensional shaping device.

### 2. Related Art

Regarding a three-dimensional shaping device, JP-T-2003-502184 discloses a device that shapes a three-dimensional shaped object by stacking a material dispensed from a dispensing unit on a stage disposed in a heated chamber.

In the three-dimensional shaping device according to JP-T-2003-502184, when a temperature in the chamber is increased in order to improve adhesion between a newly shaped layer and a previous layer, a temperature of the entire shaped object may increase and a shape of the shaped object may collapse. Therefore, inventors of the present application attempt to preferentially heat an upper layer of a shaped object using a heater that covers an entire shaping region at a position facing the stage and whose relative position changes with respect to the stage together with the dispensing unit. When such a heater is used, the heater and the stage are separated from each other as layers are stacked. Therefore, the inventors of the present application have found that, when an output of the heater is constant, an amount of heat supplied from the heater and the heated stage to the shaped object may be excessively large and a temperature of the shaped object may be excessively high at a time of stacking layers at a lower position, and the amount of heat supplied to the shaped object may be insufficient and the temperature of the shaped object may be excessively low at a time of stacking layers at a higher position.

### SUMMARY

According to an aspect of the present disclosure, a three-dimensional shaping device is provided. The three-dimensional shaping device includes: a stage having a shaping surface on which a shaping material is to be stacked; a dispensing unit configured to dispense the shaping material toward a shaping region on the shaping surface; a position changing unit configured to change a relative position between the dispensing unit and the stage; a first heating unit configured such that a relative position between the first heating unit and the stage changes together with the dispensing unit, configured to cover the shaping region at a position facing the shaping surface when viewed along a stacking direction of the shaping material, and configured to heat the shaping material stacked in the shaping region; and a control unit configured to control the dispensing unit, the first heating unit, and the position changing unit to stack layers of the shaping material in the shaping region and to shape a three-dimensional shaped object. The control unit controls the first heating unit based on a facing distance indicating a distance between the stage and the first heating unit in the stacking direction when the three-dimensional shaped object is shaped.

### BRIEF DESCRIPTION OF THE DRAWINGS

FIG. 1 is a first diagram showing a schematic configuration of a three-dimensional shaping device according to a first embodiment.

FIG. 2 is a second diagram showing a schematic configuration of the three-dimensional shaping device according to the first embodiment.

FIG. 3 is a perspective view showing a schematic configuration of a lower surface side of a screw.

FIG. 4 is a schematic plan view showing an upper surface side of a barrel.

FIG. 5 is a first schematic diagram showing an example of a positional relationship between a first heating unit and a stage.

FIG. 6 is a second schematic diagram showing an example of the positional relationship between the first heating unit and the stage.

FIG. 7 is a first diagram schematically showing a state in which a three-dimensional shaped object is shaped.

FIG. 8 is a second diagram schematically showing the state in which the three-dimensional shaped object is shaped.

FIG. 9 is a flowchart of three-dimensional shaping processing according to the first embodiment.

FIG. 10 is a diagram showing a schematic configuration of a three-dimensional shaping device according to a second embodiment.

FIG. 11 is a flowchart of three-dimensional shaping processing according to the second embodiment.

FIG. 12 is a diagram showing a schematic configuration of a three-dimensional shaping device according to a third embodiment.

FIG. 13 is a flowchart of three-dimensional shaping processing according to the third embodiment.

FIG. 14 is a flowchart of three-dimensional shaping processing according to a fourth embodiment.

### DESCRIPTION OF EXEMPLARY EMBODIMENTS

### A. First Embodiment

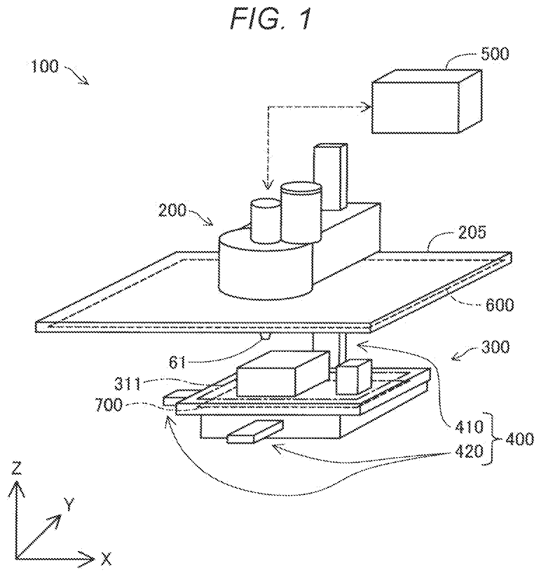

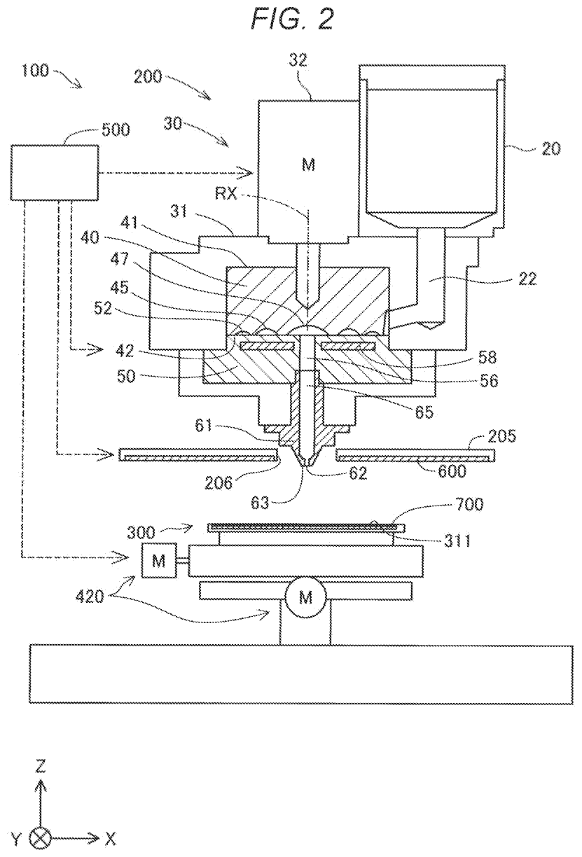

FIG. 1 is a first diagram showing a schematic configuration of a three-dimensional shaping device 100 according to a first embodiment. FIG. 2 is a second diagram showing the schematic configuration of the three-dimensional shaping device 100 according to the first embodiment. FIGS. 1 and 2 show arrows along X, Y, and Z directions orthogonal to one another. The X, Y, and Z directions are directions along an X axis, a Y axis, and a Z axis, which are three spatial axes orthogonal to one another, and each include a direction on one side along the X axis, the Y axis, and the Z axis and a direction opposite thereto. The X axis and the Y axis are axes along a horizontal plane, and the Z axis is an axis along a vertical line. In the following description, when a direction is specified, a positive direction is referred to as “+” and a negative direction is referred to as “−”, and positive and negative symbols are used together to indicate directions. A −Z direction is a vertical direction. A+Z direction is a direction opposite to the vertical direction. The −Z direction is referred to as “lower”, and the +Z direction is referred to as “upper”. In other drawings, the arrows along the X, Y, and Z directions are also appropriately represented. The X, Y, and Z directions in FIGS. 1 and 2 and the X, Y, and Z directions in other drawings represent the same directions. In the present specification, the term “orthogonal” includes a range of 90°±10°.

The three-dimensional shaping device 100 includes a dispensing unit 200, a stage 300, a position changing unit 400, a control unit 500, a first heating unit 600, and a second heating unit 700. In FIG. 2, a head moving mechanism unit 410, which will be described later, of the position changing unit 400 is omitted.

Under control of the control unit 500, the dispensing unit 200 dispenses a paste shaping material by melting a solid material onto the stage 300 for shaping serving as a base of a three-dimensional shaped object. As shown in FIGS. 1 and 2, the dispensing unit 200 includes a material accommodating unit 20 that accommodates a material for generating the shaping material, a plasticizing unit 30 that plasticizes the material supplied from the material accommodating unit 20 to generate the shaping material, and a nozzle 61 from which the generated shaping material is dispensed. The dispensing unit 200 may also be referred to as a head.

The material accommodating unit 20 accommodates a material in a state of pellets, powder, or the like. In the present embodiment, an ABS resin formed in a pellet shape is used as the material. The material accommodating unit 20 in the present embodiment is implemented by a hopper. As shown in FIG. 2, a supply path 22 that couples the material accommodating unit 20 and the plasticizing unit 30 is provided below the material accommodating unit 20. The material accommodating unit 20 supplies the material to the plasticizing unit 30 via the supply path 22.

As shown in FIG. 2, the plasticizing unit 30 includes a screw case 31, a drive motor 32, a screw 40, and a barrel 50. The plasticizing unit 30 plasticizes at least a part of the material supplied from the material accommodating unit 20, generates the paste shaping material having fluidity, and supplies the shaping material to the nozzle 61. The term “plasticization” is a concept including melting, and refers to a change from a solid state to a state having fluidity. Specifically, in a case of a material in which glass transition occurs, the term “plasticization” refers to setting a temperature of the material to be equal to or higher than a glass transition point. In a case of a material in which the glass transition does not occur, the term “plasticization” refers to setting a temperature of the material to be equal to or higher than a melting point.

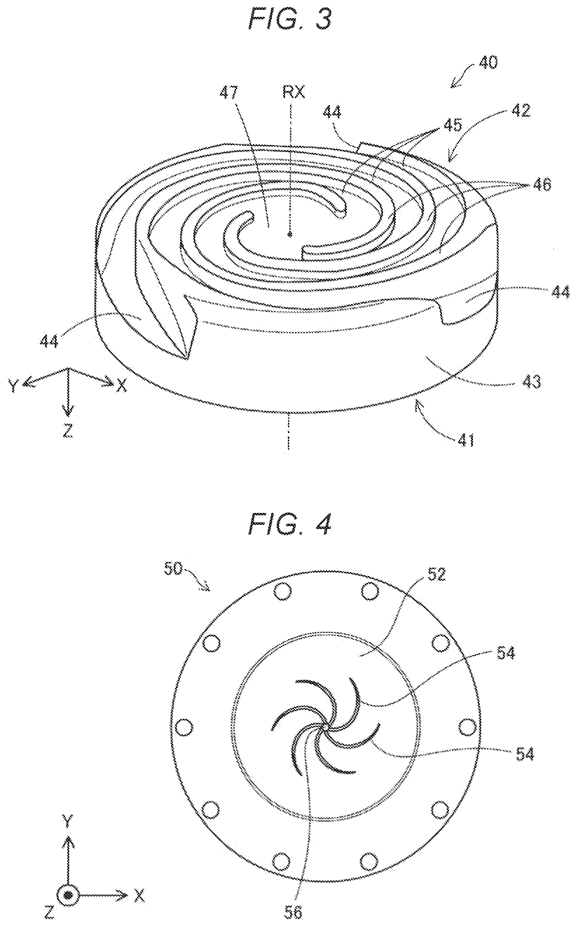

FIG. 3 is a perspective view showing a schematic configuration of a screw lower surface 42 side of the screw 40. FIG. 4 is a schematic plan view showing a barrel upper surface 52 side. The barrel upper surface 52 is an upper surface of the barrel 50. The screw 40 has a substantially cylindrical shape in which a height in an axial direction is smaller than a diameter thereof. The axial direction is a direction along a central axis RX of the screw 40. The screw 40 is disposed such that the central axis RX, which is a rotation center thereof, is parallel to the Z direction.

As shown in FIG. 2, the screw 40 is accommodated in the screw case 31. A screw upper surface 41 side of the screw 40 is coupled to the drive motor 32, and the screw 40 is rotated in the screw case 31 by a rotational drive force generated by the drive motor 32. The drive motor 32 is driven under the control of the control unit 500. The screw 40 may be driven by the drive motor 32 via a speed reducer.

As shown in FIG. 3, spiral groove portions 45 are formed in the screw lower surface 42. The supply path 22 of the material accommodating unit 20 described above communicates with the groove portion 45 from a side surface of the screw 40. The groove portions 45 are continuous to material introduction ports 44 formed in the side surface of the screw 40. The material introduction ports 44 are portions that receive the material supplied through the supply path 22 of the material accommodating unit 20. As shown in FIG. 3, in the present embodiment, three groove portions 45 are separated from one another by ridge portions 46. The number of the groove portions 45 is not limited to three, and may be one or two or more. A shape of the groove portions 45 is not limited to the spiral shape, and may be a helical shape or an involute curve shape, or may be a shape extending in an arc from a central portion 47 toward an outer periphery.

As shown in FIG. 2, the barrel 50 is disposed under the screw 40. The barrel upper surface 52 faces the screw lower surface 42, and spaces are formed between the groove portions 45 of the screw lower surface 42 and the barrel upper surface 52. In the barrel 50, a communication hole 56 communicating with a nozzle flow path 65 of the nozzle 61 to be described later is provided on the central axis RX of the screw 40. A plasticizing heater 58 is incorporated in the barrel 50 at a position facing the groove portions 45 of the screw 40. A temperature of the plasticizing heater 58 is controlled by the control unit 500.

As shown in FIG. 4, a plurality of guide grooves 54 are formed around the communication hole 56 in the barrel upper surface 52. Each of the guide grooves 54 has one end coupled to the communication hole 56 and extends spirally from the communication hole 56 toward an outer periphery of the barrel upper surface 52. The guide grooves 54 have a function of guiding the shaping material to the communication hole 56. One end of each of guide grooves 54 may not be coupled to the communication hole 56. The guide grooves 54 may not be formed in the barrel 50.

The material supplied into the groove portions 45 of the screw 40 flows along the groove portions 45 by the rotation of the screw 40 while being melted in the groove portions 45, and is guided, as the shaping material, to the central portion 47 of the screw 40. The paste shaping material flowing into the central portion 47 and having the fluidity is supplied to the nozzle 61 through the communication hole 56. All types of substances constituting the shaping material may not be melted, and it is sufficient that the shaping material is converted into a state of having the fluidity as a whole by melting at least a part of the substances constituting the shaping material.

As shown in FIG. 2, the nozzle 61 includes the nozzle flow path 65 and a tip surface 63 formed with a nozzle opening 62. The nozzle flow path 65 is a flow path of the shaping material formed in the nozzle 61, and is coupled to the communication hole 56 of the barrel 50 described above. The tip surface 63 is a surface constituting a tip portion of the nozzle 61 protruding in the −Z direction toward the stage 300. The nozzle opening 62 is a portion that is formed at an end portion of the nozzle flow path 65 on a side communicating with an atmosphere, and in which a cross section of the flow path of the nozzle flow path 65 is reduced. The shaping material generated by the plasticizing unit 30 is supplied to the nozzle 61 through the communication hole 56, and is dispensed from the nozzle opening 62 through the nozzle flow path 65.

The stage 300 is disposed at a position facing the tip surface 63 of the nozzle 61. The three-dimensional shaping device 100 dispenses the shaping material from the nozzle opening 62 of the nozzle 61 toward a shaping region on a shaping surface 311 of the stage 300, and shapes the three-dimensional shaped object by stacking layers of the shaping material in the shaping region. The shaping surface 311 is a surface of the stage 300 on which the shaping material is deposited, and is at least a part of an upper surface of the stage 300. The shaping region refers to a region in which the three-dimensional shaped object is shaped in a region formed by the shaping surface 311 and a region above the shaping surface 311. In the present embodiment, the shaping surface 311 is parallel to the X direction and the Y direction. A direction in which the shaping material is stacked may be referred to as a stacking direction. The stacking direction includes both a direction on one side along the same axis and a direction opposite thereto, and is a direction along the Z direction in the present embodiment.

The position changing unit 400 changes a relative position between the dispensing unit 200 and the stage 300. As shown in FIGS. 1 and 2, the position changing unit 400 according to the present embodiment includes the head moving mechanism unit 410 that moves the dispensing unit 200 with respect to the stage 300, and a stage moving mechanism unit 420 that moves the stage 300 with respect to the dispensing unit 200. In the present embodiment, the head moving mechanism unit 410 moves the dispensing unit 200 with respect to the stage 300 along the Z direction. The stage moving mechanism unit 420 moves the stage 300 with respect to the dispensing unit 200 along the X direction and the Y direction. The head moving mechanism unit 410 shown in FIG. 1 is implemented by a lifting device that moves the dispensing unit 200 along the Z direction while supporting the dispensing unit 200, and includes a motor for moving the dispensing unit 200 along the Z direction. The stage moving mechanism unit 420 shown in FIGS. 1 and 2 is implemented by a horizontal conveying device that moves the stage 300 along the X direction and the Y direction while supporting the stage 300, and includes a motor for moving the stage 300 along the X direction and a motor for moving the stage 300 along the Y direction. The head moving mechanism unit 410 and the stage moving mechanism unit 420 are driven under the control of the control unit 500.

Hereinafter, a change in the relative position of the dispensing unit 200 with respect to the stage 300 may be simply referred to as a movement of the dispensing unit 200. In the present embodiment, for example, the movement of the stage 300 with respect to the dispensing unit 200 in the +X direction can be rephrased as the movement of the dispensing unit 200 in the −X direction. Similarly, a change in the relative positions of the nozzle 61, the first heating unit 600, and the second heating unit 700 with respect to the stage 300 may be simply referred to as the movements of the nozzle 61, the first heating unit 600, and the second heating unit 700. In another embodiment, for example, the stage moving mechanism unit 420 may move the stage 300 with respect to the dispensing unit 200 in the Z direction, and the head moving mechanism unit 410 may move the dispensing unit 200 with respect to the stage 300 along the X direction and the Y direction. In addition, the stage moving mechanism unit 420 may move the stage 300 with respect to the dispensing unit 200 in the X direction, the Y direction, and the Z direction. In this case, the position changing unit 400 may not include the head moving mechanism unit 410. Similarly, the head moving mechanism unit 410 may move the dispensing unit 200 with respect to the stage 300 in the X direction, the Y direction, and the Z direction. In this case, the position changing unit 400 may not include the stage moving mechanism unit 420.

The first heating unit 600 shown in FIGS. 1 and 2 is disposed at a position facing the shaping surface 311 of the stage 300, and heats the shaping material stacked in the shaping region on the shaping surface 311. The first heating unit 600 in the present embodiment is disposed around the nozzle 61, and is fixed to the dispensing unit 200 via a support unit 205 similarly disposed around the nozzle 61. The first heating unit 600 and the support unit 205 in the present embodiment have an outer shape of a rectangular plate. The first heating unit 600 and the support unit 205 are disposed parallel to the shaping surface 311. A through hole 206 through which the nozzle 61 is inserted is formed at a center of the support unit 205. The first heating unit 600 is implemented such that the relative position between the first heating unit 600 and the stage 300 changes together with the dispensing unit 200. More specifically, in the present embodiment, the first heating unit 600 moves according to the dispensing unit 200 that is moved by the position changing unit 400.

The first heating unit 600 in the present embodiment is implemented by a heater. The heater implementing the first heating unit 600 may be, for example, a rubber heater, a halogen heater, a nichrome wire heater, or a carbon heater, or may be a heater that blows hot air. The number of the heaters implementing the first heating unit 600 may be one or two or more.

The first heating unit 600 covers the shaping surface 311 of the stage 300 when viewed along the Z direction. More specifically, the first heating unit 600 covers the shaping surface 311 when viewed along the Z direction regardless of how the relative position between the first heating unit 600 and the stage 300 is changed by the position changing unit 400.

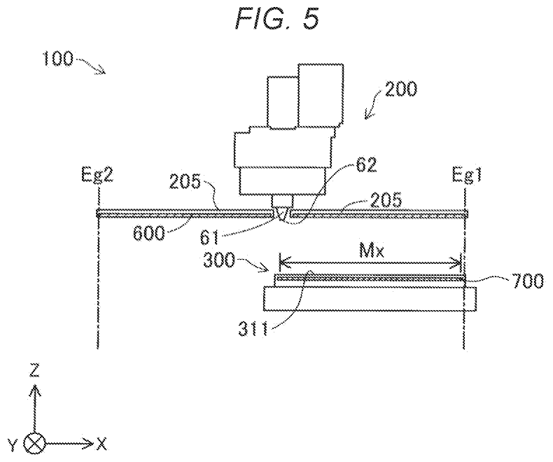

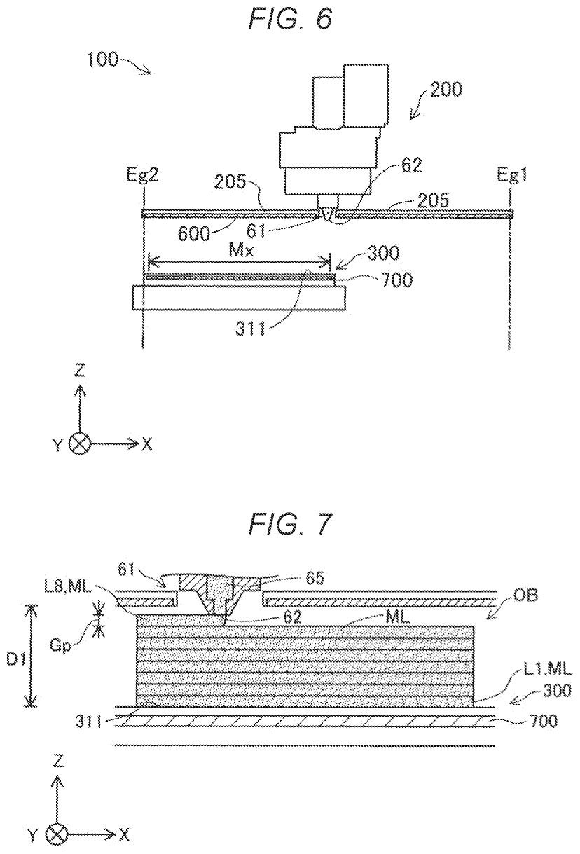

FIG. 5 is a first schematic view showing an example of a positional relationship between the first heating unit 600 and the stage 300. FIG. 6 is a second schematic view showing an example of the positional relationship between the first heating unit 600 and the stage 300. FIG. 5 shows a state in which the dispensing unit 200 is positioned in the most −X direction with respect to the stage 300 in the present embodiment. FIG. 6 shows a state in which the dispensing unit 200 is positioned in the most +X direction with respect to the stage 300. In FIGS. 5 and 6, a range Mx of the shaping region in the X direction according to the present embodiment is indicated by a solid line arrow. In the example in FIG. 5, the nozzle opening 62 of the nozzle 61 is positioned at a position overlapping an end of the range Mx in the −X direction when viewed along the Z direction. In the example in FIG. 6, the nozzle opening 62 is positioned at a position overlapping an end of the range Mx in the +X direction when viewed along the Z direction. In FIGS. 5 and 6, one end Eg1 and the other end Eg2 of the first heating unit 600 in the X direction are indicated by one-dot chain lines.

As shown in FIGS. 5 and 6, the range Mx of the shaping region in the X direction is positioned between the one end Eg1 and the other end Eg2 of the first heating unit 600 in the X direction regardless of how the relative position between the first heating unit 600 and the stage 300 in the X direction is changed by the position changing unit 400. That is, the shaping region is disposed between the one end Eg1 and the other end Eg2 of the first heating unit 600 in the X direction regardless of how the relative position between the first heating unit 600 and the stage 300 is changed in the X direction by the position changing unit 400. It can also be said that the shaping region is formed inside an outer peripheral edge of the first heating unit 600 in the X direction. Similarly, the shaping region is also formed inside the outer peripheral edge of the first heating unit 600 in the Y direction although not shown in the drawings.

The second heating unit 700 heats the stage 300. In the present embodiment, the second heating unit 700 is implemented by a rectangular plate-shaped heater, and is provided in the stage 300. More specifically, the second heating unit 700 is embedded in the stage 300, and is disposed at a position of the shaping surface 311 in the −Z direction. The heater implementing the second heating unit 700 may be, for example, a halogen heater, a nichrome wire heater, or a carbon heater. The number of the heaters implementing the second heating unit 700 may be one or two or more.

The control unit 500 shown in FIGS. 1 and 2 is a control device that controls an overall operation of the three-dimensional shaping device 100. The control unit 500 is implemented by a computer including one or a plurality of processors, a memory, and an input and output interface for inputting and outputting signals to and from an outside. The control unit 500 has various functions of performing three-dimensional shaping processing by the processor executing a program or a command read from a main storage device. Instead of being implemented by a computer, the control unit 500 may be implemented by a configuration of combining a plurality of circuits in order to implement at least a part of the functions.

FIG. 7 is a first diagram schematically showing a state in which a three-dimensional shaped object OB is shaped by the three-dimensional shaping processing. FIG. 7 shows a state in which an eighth layer L8 which is an eighth layer of the three-dimensional shaped object OB is being shaped. In the shaping processing, the control unit 500 appropriately controls the dispensing unit 200 and the position changing unit 400 described above according to shaping data to be described later to dispense the shaping material from the nozzle opening 62 of the nozzle 61 toward the stage 300, solidify the shaping material on the shaping surface 311, and stack the layers of the shaping material in the Z direction, thereby shaping the three-dimensional shaped object OB. The solidification of the material means that the dispensed shaping material loses the fluidity. In the present embodiment, the shaping material is thermally shrunk and loses plasticity due to a decrease in the temperature of the shaping material, and is solidified.

More specifically, as shown in FIG. 7, in the three-dimensional shaping processing, the control unit 500 causes the shaping material to be dispensed from the nozzle 61 while causing the nozzle 61 to move in the X direction and the Y direction. The shaping material dispensed from the nozzle 61 is continuously deposited in a moving direction of the nozzle 61, thereby forming a linear portion which is a portion linearly extending along a movement path of the nozzle 61. The control unit 500 forms layers ML by repeating the formation of the linear portion by traversal of the nozzle 61. After forming one layer ML, the control unit 500 causes the nozzle 61 to move with respect to the stage 300 in the Z direction, and further stacks the layers ML on the layer ML formed so far to form the shaped object. Therefore, in the shaping processing, the dispensing unit 200 and the nozzle 61 are positioned closest to the shaping surface 311 when a first layer L1 which is a first layer of the three-dimensional shaped object OB is shaped, and then move away from the shaping surface 311 as upper layers are stacked. Hereinafter, when n is any natural number, an n-th layer of the three-dimensional shaped object OB may be referred to as an n-th layer.

When the layers are stacked, the control unit 500 causes the shaping material to be dispensed from the nozzle 61 while maintaining a distance between the nozzle 61 of the dispensing unit 200 and a dispensing target. A dispensing target is the shaping surface 311 when the shaping material is dispensed onto the shaping surface 311, and is an upper surface of the dispensed shaping material when the shaping material is dispensed onto the dispensed shaping material. A distance between the nozzle 61 and the dispensing target may be referred to as a gap Gp.

In the three-dimensional shaping processing, when the n-th layer is stacked, the control unit 500 controls the first heating unit 600 to heat the shaping material constituting an (n−1)-th layer which is a layer stacked in the shaping region on the stage 300, and dispenses the shaping material onto the (n−1)-th layer. Accordingly, the control unit 500 stacks the n-th layer on the (n−1)-th layer while maintaining a temperature of the (n−1)-th layer at a temperature for improving interlayer adhesion between the n-th layer and the (n−1)-th layer. Further, when the n-th layer is stacked, a temperature of a layer below the (n−1)-th layer is preferably maintained at a temperature for maintaining a shape of the layer. The temperature for maintaining the shape of the layer is lower than the temperature for improving the interlayer adhesion. In the present embodiment, the first heating unit 600 faces the shaping surface 311 and covers the shaping surface 311 when viewed along the Z direction. Therefore, while the entire shaping material stacked in the shaping region is heated, particularly, an upper layer of the three-dimensional shaped object OB, such as an uppermost layer, can be preferentially heated. Therefore, it is easy to implement both the maintenance of the shape of the layer and the improvement of the interlayer adhesion.

More specifically, in the three-dimensional shaping processing, the control unit 500 controls the first heating unit 600 based on a facing distance indicating a distance between the stage 300 and the first heating unit 600 in the Z direction. In the present embodiment, in the three-dimensional shaping processing, the control unit 500 executes first control in which a set temperature of the first heating unit 600 is set to a first set temperature when the facing distance is a first distance, and the set temperature of the first heating unit 600 is set to a second set temperature higher than the first set temperature when the facing distance is a second distance longer than the first distance.

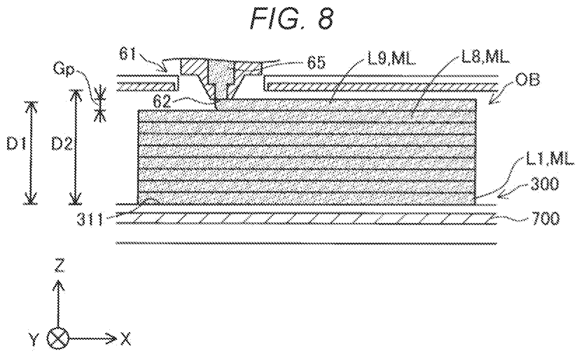

FIG. 8 is a second diagram schematically showing a state in which the three-dimensional shaped object OB is shaped by the three-dimensional shaping processing. FIG. 8 shows a state in which a ninth layer L9 of the three-dimensional shaped object OB is being shaped. In a case in which the facing distance when the eighth layer L8 is shaped is defined as a distance D1 as shown in FIG. 7, and in which the facing distance when the ninth layer L9 is shaped is defined as a distance D2 as shown in FIG. 8, the distance D2 is longer than the distance D1. When the ninth layer L9 is shaped as shown in FIG. 8, the control unit 500 sets the set temperature of the first heating unit 600 to be higher than the set temperature when the eighth layer L8 is shaped as shown in FIG. 7. That is, in the examples in FIGS. 7 and 8, the distance D1 corresponds to the first distance described above, and the distance D2 corresponds to the second distance described above. The set temperature of the first heating unit 600 when the eighth layer L8 is shaped corresponds to the first set temperature described above, and the set temperature of the first heating unit 600 when the ninth layer L9 is shaped corresponds to the second set temperature.

In the example in FIG. 7, since the facing distance is shorter than that in the example in FIG. 8, heat of the first heating unit 600 is more easily transferred to the stage 300, and a space between the first heating unit 600 and the stage 300 is reduced. In addition, since the number of present layers that are stacked is small, an amount of heat required to heat the present layers is small. In contrast, in the example in FIG. 8, as compared to the example in FIG. 7, the heat of the first heating unit 600 is less likely to be transferred to the stage 300, and the space between the first heating unit 600 and the stage 300 increases. In addition, since the number of the present layers is large, the amount of heat required to heat the present layers is large. Therefore, for example, in a case in which an output of the first heating unit 600 is kept constant regardless of the facing distance, when the number of the present layers is small, the amount of heat supplied to the three-dimensional shaped object OB is excessively large, and the temperature of the three-dimensional shaped object is excessively high. Therefore, a shape of the three-dimensional shaped object OB may be broken. Similarly, when the number of the present layers is large, the amount of heat supplied to the three-dimensional shaped object OB is insufficient, and a temperature of the three-dimensional shaped object OB may be excessively low. In this case, for example, the interlayer adhesion may be reduced due to the heat being taken by a layer below the uppermost layer from the uppermost layer, or deformation such as warpage due to rapid cooling may occur in a layer that is less likely to be affected by the heat of the first heating unit 600 and heat of the stage 300, for example, a layer in the vicinity of a middle of the three-dimensional shaped object OB in the stacking direction. In the present embodiment, as described above, since the first heating unit 600 is controlled based on the facing distance, it is possible to prevent such collapse of the shape of the three-dimensional shaped object OB, a decrease in the interlayer adhesion, the deformation due to the rapid cooling, and the like.

In the present embodiment, in addition to the first heating unit 600, the control unit 500 controls the second heating unit 700 in the three-dimensional shaping processing. In the three-dimensional shaping processing, the three-dimensional shaped object OB shaped in the shaping region can also be heated from the stage 300 side in the Z direction by controlling the second heating unit 700 in addition to the first heating unit 600. That is, since the three-dimensional shaped object OB can be heated not only from an upper side but also from a lower side, for example, the deformation due to the rapid cooling of a lower layer of the three-dimensional shaped object OB can be prevented even when the number of the present layers is large. In addition, the amount of heat supplied to the three-dimensional shaped object from the upper side of the three-dimensional shaped object can be controlled by the first heating unit 600, and the amount of heat supplied to the three-dimensional shaped object from the lower side via the stage 300 can be controlled by the second heating unit 700. Therefore, for example, as described above, it is possible to more easily implement control for maintaining the temperature of the layer below the uppermost layer at the temperature at which the shape of the layer is maintained while maintaining the temperature of the uppermost layer at the temperature at which the improvement of the interlayer adhesion is implemented.

In the present embodiment, in the three-dimensional shaping processing, the control unit 500 controls the first heating unit 600 described above based on not only the facing distance but also a set temperature of the second heating unit 700. When the control unit 500 controls the second heating unit 700 in the three-dimensional shaping processing, the temperature of the stage 300 is changed by heat of the second heating unit 700. Therefore, by controlling the first heating unit 600 based on not only the facing distance but also the set temperature of the second heating unit 700, the temperature of the three-dimensional shaped object during the shaping can be controlled more appropriately. It is preferable that the control unit 500 controls the first heating unit 600 and the second heating unit 700 such that the temperature of the stage 300 does not exceed a heat-resistant temperature of the motor constituting the stage moving mechanism unit 420.

In the present embodiment, the control unit 500 determines the set temperature of the first heating unit 600 to be higher than the set temperature of the second heating unit 700 regardless of how the facing distance changes. Therefore, as described above, it is possible to more easily implement the control for maintaining the temperature of the layer below the uppermost layer at the temperature at which the shape of the layer is maintained while maintaining the temperature of the uppermost layer at the temperature at which the improvement of the interlayer adhesion is implemented. In addition, since the temperature of the layer in the vicinity of the middle in the stacking direction, which is far from the first heating unit 600 and the second heating unit 700, can be increased, the deformation due to the rapid cooling of the layer in the vicinity of the middle can be prevented from occurring. In another embodiment, the control unit 500 may determine the set temperature of the first heating unit 600 to be the temperature higher than the set temperature of the second heating unit 700, or may determine the set temperature of the first heating unit 600 to be the same as the set temperature of the second heating unit 700.

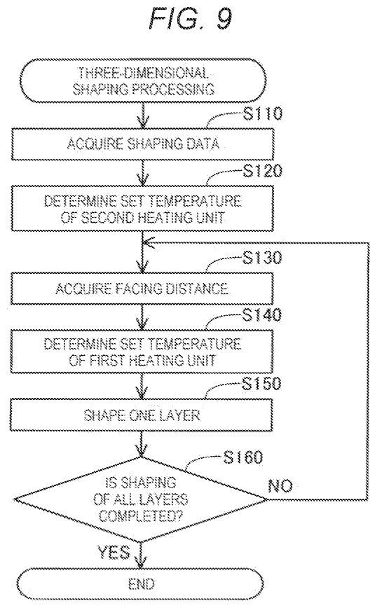

FIG. 9 is a flowchart of the three-dimensional shaping processing according to the present embodiment. The three-dimensional shaping processing is performed when, for example, the control unit 500 receives a predetermined start operation from a user.

In step S110, the control unit 500 acquires the shaping data. In the present embodiment, in step S110, the control unit 500 acquires the shaping data from an external computer, a recording medium, or the like.

The shaping data includes shaping pass data representing the movement path of the nozzle 61 for each layer forming the three-dimensional shaped object. The shaping pass data is associated with dispensing amount data representing a dispensing amount of the material dispensed from the nozzle 61. In the present embodiment, the dispensing amount represented by the dispensing amount data is an amount of the shaping material dispensed per unit time in the movement path. The shaping data is generated based on, for example, layer data in which the shape of the three-dimensional shaped object are sliced into layers. The layer data is generated based on, for example, shape data representing the shape of the three-dimensional shaped object. In another embodiment, for example, a total amount of the shaping material dispensed in all the movement paths may be associated with each movement path as the dispensing amount data.

In step S120, the control unit 500 determines the set temperature of the second heating unit 700. In the present embodiment, in step S120, the control unit 500 sets the set temperature of the second heating unit 700 to, for example, a temperature designated by the user.

In step S130, the control unit 500 acquires the facing distance. In the present embodiment, in step S130, the control unit 500 acquires a Z coordinate representing a coordinate of the nozzle 61 in the Z direction based on a control value of the head moving mechanism unit 410, and calculates the distance between the shaping surface 311 and a lower surface of the first heating unit 600 as the facing distance based on the acquired Z coordinate, thereby acquiring the facing distance. For example, when step S130 is executed for a first time, a distance between the shaping surface 311 and the first heating unit 600 when the first layer of the three-dimensional shaped object is shaped is acquired as the facing distance.

In step S140, the control unit 500 determines the set temperature of the first heating unit 600. In the present embodiment, in step S140, the control unit 500 determines, based on the facing distance acquired in step S130 and the set temperature of the second heating unit 700 determined in step S120, the set temperature of the first heating unit 600 using a relationship between the facing distance and the set temperature of the first heating unit 600. The relationship is predetermined for each set temperature of the second heating unit 700. In the present embodiment, the relationship between the facing distance and the set temperature of the first heating unit 600 used in step S140 is represented by a monotonically increasing function that defines the relationship between the facing distance and the set temperature of the first heating unit 600 for each set temperature of the second heating unit 700. This function is determined by an experiment, for example, as a function for implementing the improvement of the interlayer adhesion and preventing of the collapse of the shape of the layer described above regardless of the number of the present layers. In the present embodiment, this function is defined such that the set temperature of the first heating unit 600 is higher than the temperature of the second heating unit 700 regardless of the facing distance. In another embodiment, the relationship between the facing distance and the set temperature of the first heating unit 600 may be represented by, for example, a map defining the relationship between the facing distance and the set temperature of the first heating unit 600.

In step S150, the control unit 500 stacks layers of the shaping material according to the shaping data acquired in step S110. More specifically, in step S150, the control unit 500 controls the dispensing unit 200, the position changing unit 400, the first heating unit 600, and the second heating unit 700 as described with reference to FIG. 7 to shape one layer of the three-dimensional shaped object in the shaping region. For example, in step S150 that is executed for a first time, the first layer of the three-dimensional shaped object is stacked directly on the shaping surface 311. In the present embodiment, as described above, in step S140 executed before step S150, the set temperature of the first heating unit 600 is set based on the facing distance and the set temperature of the second heating unit 700. Therefore, it can be said that the control unit 500 controls the first heating unit 600 based on the facing distance and the set temperature of the second heating unit 700 in step S150.

In step S160, the control unit 500 determines whether the shaping of all layers of the three-dimensional shaped object is completed. When the control unit 500 determines in step S160 that the shaping of all the layers of the three-dimensional shaped object is completed, the control unit 500 ends the three-dimensional shaping processing. When the control unit 500 ends the three-dimensional shaping processing, the control unit 500 may not immediately turn off the first heating unit 600 and the second heating unit 700, and may maintain a state of turning on the first heating unit 600 and the second heating unit 700 for a predetermined period. When the control unit 500 determines in step S160 that the shaping of all the layers of the three-dimensional shaped object is not completed, the processing returns to step S130. In this way, the control unit 500 shapes the three-dimensional shaped object by repeatedly stacking the layer of the shaping material in the shaping region.

The three-dimensional shaping device 100 according to the present embodiment described above includes the first heating unit 600 configured such that the relative position with respect to the stage 300 changes together with the dispensing unit 200, configured to cover the shaping region when viewed along the Z direction at the position facing the shaping surface 311, and configured to heat the shaping material stacked in the shaping region, and the control unit 500 controls the first heating unit 600 based on the facing distance when the three-dimensional shaped object is shaped. In such an aspect, the first heating unit 600 can preferentially heat the upper layer while heating the entire three-dimensional shaped object. In addition, since the first heating unit 600 is controlled based on the facing distance, the temperature of the three-dimensional shaped object can be appropriately controlled regardless of a degree of progress of the stacking. Therefore, the shape of the three-dimensional shaped object can be prevented from collapsing, and the interlayer adhesion can be improved.

In the present embodiment, the control unit 500 sets the set temperature of the first heating unit 600 to the first set temperature when the facing distance is the first distance, and sets the set temperature of the first heating unit 600 to the second set temperature higher than the first set temperature when the facing distance is the second distance longer than the first distance. Therefore, the temperature of the three-dimensional shaped object can be appropriately controlled by simple control regardless of the degree of progress of the stacking.

In the present embodiment, the three-dimensional shaping device 100 includes the second heating unit 700 that heats the stage 300, and the control unit 500 controls the second heating unit 700 when the three-dimensional shaped object is shaped. In such an aspect, by controlling the second heating unit 700, the three-dimensional shaped object can also be heated from the stage 300 side in the stacking direction, and the amount of heat supplied from the stage 300 to the three-dimensional shaped object can be controlled. Therefore, the temperature of the three-dimensional shaped object can be controlled more appropriately.

In the present embodiment, the control unit 500 controls the first heating unit 600 based on not only the facing distance but also the set temperature of the second heating unit 700 when the three-dimensional shaped object is shaped. Accordingly, the first heating unit 600 can be controlled in consideration of an influence of the heat supplied from the second heating unit 700 to the three-dimensional shaped object via the stage 300 without providing a sensor that measures the temperature of the stage 300 or a temperature of the layer. Therefore, the temperature of the three-dimensional shaped object can be more precisely controlled with a simple configuration.

### B. Second Embodiment

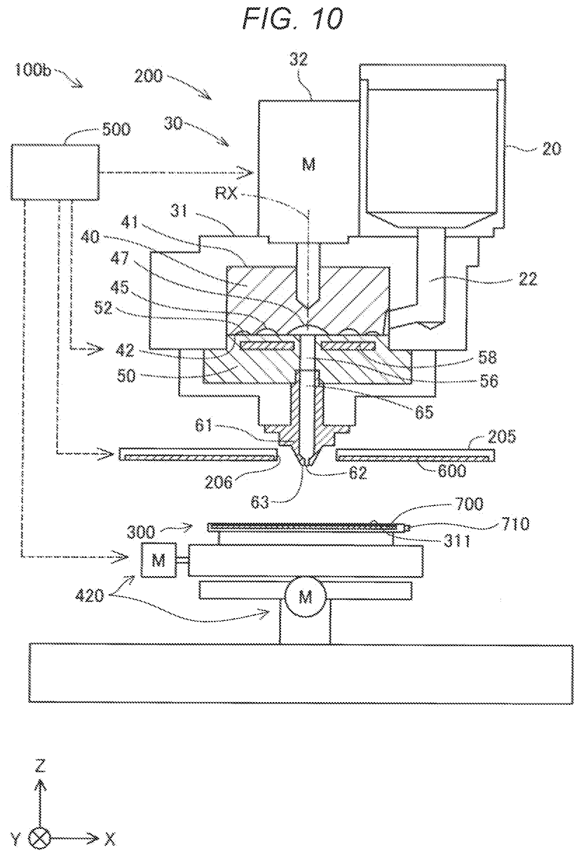

FIG. 10 is a diagram showing a schematic configuration of a three-dimensional shaping device 100b according to a second embodiment. Different from the first embodiment, the three-dimensional shaping device 100b according to the present embodiment includes a first sensor 710 that measures a temperature of the stage 300. In the present embodiment, the control unit 500 controls the first heating unit 600 based on a facing distance and a measurement value of the first sensor 710 when a three-dimensional shaped object is shaped. That is, in the present embodiment, the control unit 500 does not control the first heating unit 600 based on a set temperature of the second heating unit 700. Parts of a configuration of the three-dimensional shaping device 100b according to the present embodiment that are not particularly described are the same as those according to the first embodiment.

In the present embodiment, the first sensor 710 is implemented by a thermistor, and is provided on the stage 300. A measurement value of the temperature of the stage 300 measured by the first sensor 710 is transmitted to the control unit 500. In another embodiment, the first sensor 710 may be implemented by, for example, a thermocouple or a radiation thermometer.

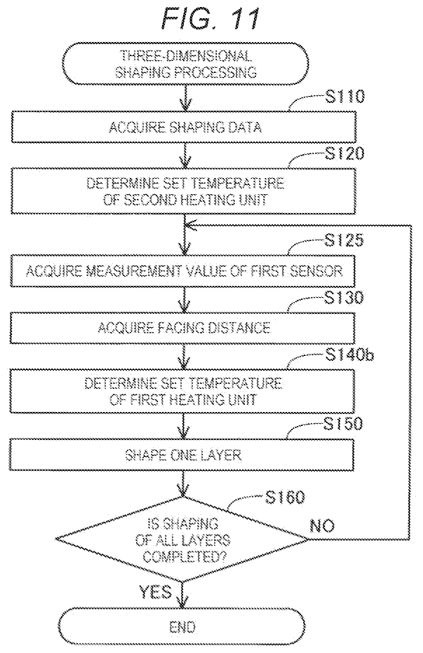

FIG. 11 is a flowchart of three-dimensional shaping processing according to the second embodiment. In FIG. 11, the same steps as those in FIG. 9 described in the first embodiment are denoted by the same reference signs as those in FIG. 9.

In step S125, the control unit 500 acquires the measurement value of the first sensor 710. In step S140b, the control unit 500 determines a set temperature of the first heating unit 600 using a predetermined relationship between the facing distance and the set temperature of the first heating unit 600 based on the facing distance acquired in step S130 and the measurement value of the first sensor 710 acquired in step S130. In the present embodiment, the relationship between the facing distance and the set temperature of the first heating unit 600 is represented by a monotonically increasing function in which the relationship between the facing distance and the set temperature of the first heating unit 600 is defined for each temperature of the stage 300. For example, as described in the first embodiment, the function is determined as a function for implementing improvement of interlayer adhesion and preventing of collapse of a shape of a layer regardless of the number of present layers.

In step S150, the control unit 500 stacks layers of a shaping material in the same manner as in step S150 in FIG. 9. In the present embodiment, in step S140b executed prior to step S150, the set temperature of the first heating unit 600 is set based on the facing distance and the measurement value of the first sensor 710. Therefore, it can be said that the control unit 500 controls the first heating unit 600 based on the facing distance and the measurement value of the first sensor 710 in step S150.

The three-dimensional shaping device 100b according to the present embodiment described above includes the first sensor 710 that measures the temperature of the stage 300, and the control unit 500 controls the first heating unit 600 based on the facing distance and the measurement value of the first sensor 710 when the three-dimensional shaped object is shaped. Accordingly, the first heating unit 600 can be controlled in consideration of an influence of heat supplied from the stage 300 to the three-dimensional shaped object based on the measurement value of the first sensor 710. Therefore, a temperature of the three-dimensional shaped object can be controlled more precisely.

### C. Third Embodiment

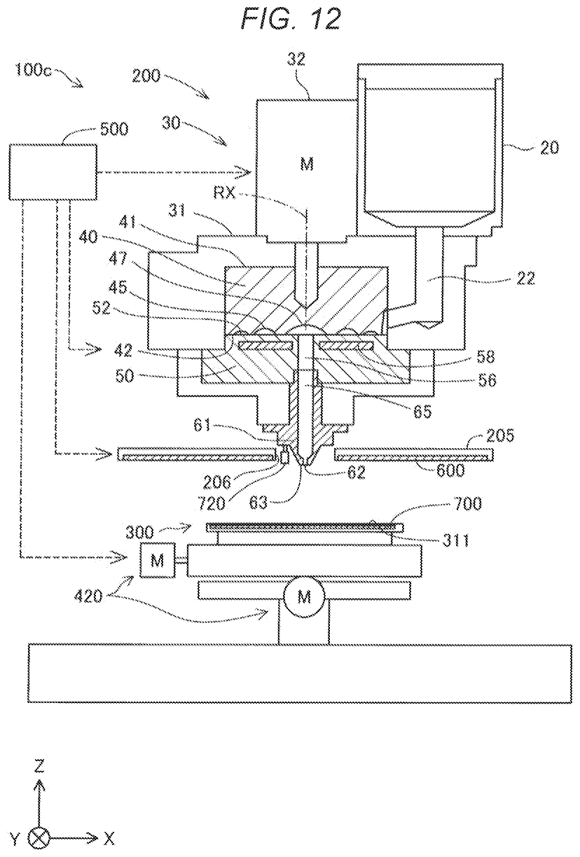

FIG. 12 is a diagram showing a schematic configuration of a three-dimensional shaping device 100c according to a third embodiment. Different from the first embodiment, the three-dimensional shaping device 100c according to the present embodiment includes a second sensor 720 that measures a temperature of a layer. In the present embodiment, the control unit 500 controls the first heating unit 600 based on a measurement value of the second sensor 720 in addition to a facing distance and a set temperature of the second heating unit 700 when a three-dimensional shaped object is shaped. Parts of a configuration of the three-dimensional shaping device 100c according to the present embodiment that are not particularly described are the same as those according to the first embodiment.

In the present embodiment, the second sensor 720 is disposed at a position facing the stage 300, and measures the temperature of the layer of a shaping material stacked in a shaping region on the shaping surface 311. The second sensor 720 is implemented such that a relative position between the second sensor 720 and the stage 300 changes together with the dispensing unit 200. The second sensor 720 in the present embodiment is implemented by a radiation thermometer, and is fixed to the nozzle 61. The second sensor 720 is disposed at a position not overlapping the nozzle opening 62 and overlapping the through hole 206 formed in the support unit 205 when viewed along a Z direction. A lower end of the second sensor 720 is positioned above the nozzle opening 62. The second sensor 720 is controlled by the control unit 500, and a measurement value of the temperature of the layers measured by the second sensor 720 is transmitted to the control unit 500. In another embodiment, the second sensor 720 may be, for example, a contact-type thermometer implemented by a thermistor, a thermocouple, or the like.

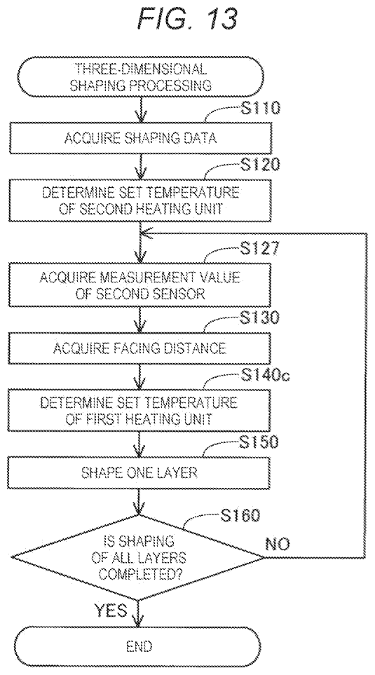

FIG. 13 is a flowchart of three-dimensional shaping processing according to the third embodiment. In FIG. 13, the same steps as those in FIG. 9 described in the first embodiment are denoted by the same reference signs as those in FIG. 9.

In step S127, the control unit 500 measures the temperature of the layers by the second sensor 720, and acquires a measurement value thereof. In the present embodiment, in step S127, the control unit 500 measures a temperature of an uppermost layer which is an uppermost layer stacked at a time of executing step S127.

In step S140c, the control unit 500 determines a set temperature of the first heating unit 600 using a predetermined relationship between the facing distance and the set temperature of the first heating unit 600 based on the facing distance acquired in step S130 and the measurement value of the second sensor 720 acquired in step S127. In the present embodiment, similarly to the first embodiment, a relationship between the facing distance and the set temperature of the first heating unit 600 is represented by a monotonically increasing function in which the relationship between the facing distance and the set temperature of the first heating unit 600 is defined for each set temperature of the second heating unit 700. In the present embodiment, in step S140c, the control unit 500 determines the set temperature of the first heating unit 600 to be a temperature obtained by adding a difference between a predicted value of the temperature of the uppermost layer and the measurement value acquired in step S127 to the temperature determined based on the facing distance using the above-described function. The predicted value of the temperature of the uppermost layer is a temperature predicted based on, for example, the facing distance, the set temperature of the first heating unit 600, and the set temperature of the second heating unit 700, and is predicted using, for example, a function defined by an experiment.

In step S150, the control unit 500 stacks layers of the shaping material in the same manner as in step S150 in FIG. 9. In the present embodiment, in step S140c executed prior to step S150, the set temperature of the first heating unit 600 is set based on the facing distance, the set temperature of the second heating unit 700, and the measurement value of the second sensor 720. Therefore, it can be said that the control unit 500 controls the first heating unit 600 based on the facing distance, the set temperature of the second heating unit 700, and the measurement value of the first sensor 710 in step S150.

The three-dimensional shaping device 100c according to the present embodiment described above includes the second sensor 720 that measures the temperature of the layer, and the control unit 500 controls the first heating unit 600 based on the facing distance and the measurement value of the second sensor 720 when the three-dimensional shaped object is shaped. Accordingly, the first heating unit 600 can be controlled in consideration of the actual temperature of the layer measured by the second sensor 720. Therefore, a temperature of the three-dimensional shaped object can be controlled more precisely.

### D. Fourth Embodiment

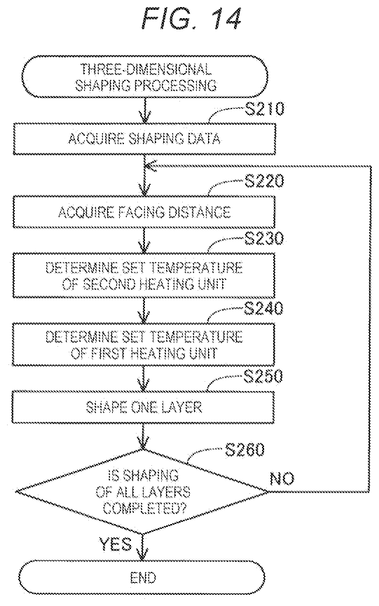

FIG. 14 is a flowchart of three-dimensional shaping processing according to a fourth embodiment. In the present embodiment, different from the first embodiment, the control unit 500 controls not only the first heating unit 600 but also the second heating unit 700 based on a facing distance in the three-dimensional shaping processing. Parts of a configuration of the three-dimensional shaping device 100 according to the present embodiment that are not particularly described are the same as those according to the first embodiment.

Step S210 and step S220 are the same as step S110 and step S130 in FIG. 9, respectively, and thus the description thereof will be omitted.

In step S230, the control unit 500 determines a set temperature of the second heating unit 700 based on the facing distance acquired in step S220. In the present embodiment, in the three-dimensional shaping processing, the control unit 500 executes second control in which the set temperature of the second heating unit 700 is set to a third set temperature when the facing distance is a third distance, and the set temperature of the second heating unit 700 is set to a fourth set temperature higher than the third set temperature when the facing distance is a fourth distance longer than the third distance. For example, in the examples in FIGS. 7 and 8 described above, the distance D1 in FIG. 7 corresponds to the third distance, and the distance D2 in FIG. 8 corresponds to the fourth distance. Further, the set temperature of the second heating unit 700 when the eighth layer L8 is shaped corresponds to the third set temperature, and the set temperature of the second heating unit 700 when the ninth layer L9 is shaped corresponds to the fourth set temperature.

Step S240 and step S250 are the same as step S140 and step S150 in FIG. 9, respectively, and thus the description thereof will be omitted. In step S260, similarly to step S160 in FIG. 9, the control unit 500 determines whether shaping of all layers of the three-dimensional shaped object is completed. When the control unit 500 determines that the shaping of all the layers of the three-dimensional shaped object is completed, the control unit 500 ends the three-dimensional shaping processing. When the control unit 500 determines that the shaping of all the layers of the three-dimensional shaped object is not completed, the processing returns to step S220.

According to the three-dimensional shaping device 100 in the present embodiment described above, the control unit 500 controls the second heating unit 700 based on the facing distance when the three-dimensional shaped object is shaped. Therefore, for example, compared to a case in which the second heating unit 700 is controlled to have a constant output regardless of the facing distance, a temperature of the three-dimensional shaped object can be controlled more appropriately.

Further, in the present embodiment, the control unit 500 sets the set temperature of the second heating unit 700 to the third set temperature when the facing distance is the third distance, and sets the set temperature of the second heating unit 700 to the fourth set temperature higher than the third set temperature when the facing distance is the fourth distance longer than the third distance. Therefore, the temperature of the three-dimensional shaped object can be controlled more appropriately by simple control regardless of the degree of progress of the stacking.

In another embodiment, the control unit 500 may not execute the second control when controlling the second heating unit 700 based on the facing distance. For example, when the facing distance is the fourth distance, the control unit 500 may set the set temperature of the second heating unit 700 to a temperature lower than the set temperature of the second heating unit 700 when the facing distance is the third distance. Accordingly, for example, in combination with the first control, an uppermost layer can be efficiently heated by the second heating unit 700 in a relatively early period of stacking in which heat of the second heating unit 700 is more likely to contribute to heating of the uppermost layer than heat of the first heating unit 600, that is, in a period in which the number of present layers is small, and the uppermost layer can be efficiently heated by the first heating unit 600 in a relatively late period of the stacking in which the heat of the first heating unit 600 is more likely to contribute to the heating of the uppermost layer, that is, in a period in which the number of present layers is large. In addition, for example, the control unit 500 may control the set temperature of the second heating unit 700 to be constant until the stacking of the predetermined number of layers is completed, and may lower the set temperature of the second heating unit 700 after the stacking of the layers is completed. In this case, for example, the control unit 500 may turn off the second heating unit 700 after the stacking of the predetermined number of layers is completed.

### E. Another Embodiment

(E-1) In the aspect described above, the control unit 500 executes first control in three-dimensional shaping processing. In contrast, the control unit 500 may not execute the first control in the three-dimensional shaping processing. For example, the control unit 500 may control the first heating unit 600 based on a facing distance using a function that is not a monotonically increasing function defining a relationship between the facing distance and a set temperature of the first heating unit 600. In addition, for example, in a case in which the second control described in the fourth embodiment is executed, when the facing distance is a second distance, the control unit 500 may set the set temperature of the first heating unit 600 to a temperature lower than the set temperature of the first heating unit 600 when the facing distance is a first distance. In addition, for example, the control unit 500 may control the set temperature of the first heating unit 600 to be constant until stacking of the predetermined number of layers is completed, and may increase the set temperature of the first heating unit 600 after the stacking of the layers is completed.

(E-2) In the embodiments described above, the second heating unit 700 is provided. In contrast, the second heating unit 700 may not be provided. Even in this case, the control unit 500 may control the first heating unit 600 based on a measurement value of the first sensor 710 as in the second embodiment. Accordingly, since the first heating unit 600 can be controlled in consideration of a temperature change of the stage 300 due to heat of the first heating unit 600, a temperature of a three-dimensional shaped object can be controlled more precisely. Similarly, even when the second heating unit 700 is not provided, the control unit 500 may control the first heating unit 600 based on a measurement value of the second sensor 720 as in the third embodiment.

(E-3) In the embodiments described above, the facing distance may be calculated based on, for example, a detection value detected by a non-contact type range finder including a laser light emitting unit and a laser light receiving unit or a contact type range finder disposed at the stage 300 or a position facing the stage 300. The facing distance may be represented by, for example, the number of present layers or a value of n of an n-th stacked layer. In this case, the larger the number of present layers or the value of n is, the larger the facing distance is.

(E-4) In the embodiments described above, the plasticizing unit 30 includes the screw 40, which is a flat screw, and the barrel 50. In contrast, the plasticizing unit 30 may not include the flat screw and the barrel 50. For example, the plasticizing unit 30 may include an in-line screw, and may plasticize a material by rotating the in-line screw to generate a shaping material.

(E-5) In the embodiments described above, the three-dimensional shaping device 100 may include a plurality of nozzles 61, and for example, may include one or more dispensing units 200 each including the plurality of nozzles 61, or may include a plurality of dispensing units 200 each including one nozzle 61.

(E-6) In the embodiments described above, the dispensing unit 200 is implemented as a head that dispenses a material formed in a pellet shape. In contrast, the dispensing unit 200 may be implemented as, for example, a head that plasticizes a filament-shaped material and that dispenses the plasticized material.

(E-7) In the embodiments described above, a resin material formed in a pellet shape is used as a raw material to be supplied to the material accommodating unit 20. In contrast, the three-dimensional shaping device 100 can shape the three-dimensional shaped object using various materials, such as a thermoplastic material, a metal material, and a ceramic material, as a main material. Here, the “main material” refers to a material serving as a center component for forming a shape of the three-dimensional shaped object, and refers to a material having a content of 50 mass % or more in the three-dimensional shaped object. The above-described shaping material includes a material obtained by melting the main material alone or a material obtained by melting the main material and a part of components contained in the main material into a paste shape.

When the thermoplastic material is used as the main material, the plasticizing unit 30 generates the shaping material by plasticizing this material. A term “plasticize” means that heat is applied to the thermoplastic material to melt the material.

Examples of the thermoplastic material may include the following thermoplastic resin materials.

### Examples of Thermoplastic Resin Material

General-purpose engineering plastics such as a polypropylene resin (PP), a polyethylene resin (PE), a polyacetal resin (POM), a polyvinyl chloride resin (PVC), a polyamide resin (PA), an acrylonitrile-butadiene-styrene resin (ABS), a polylactic acid resin (PLA), a polyphenylene sulfide resin (PPS), polyether ether ketone (PEEK), polycarbonate (PC), modified polyphenylene ether, polybutylene terephthalate, and polyethylene terephthalate, and engineering plastics such as polysulfone, polyether sulfone, polyphenylene sulfide, polyarylate, polyimide, polyamideimide, polyetherimide, and polyether ether ketone

An additive such as a wax, a flame retardant, an antioxidant, and a heat stabilizer may be mixed into the thermoplastic material, in addition to a pigment, a metal, and a ceramic. In the plasticizing unit 30, the thermoplastic material is plasticized and converted into a molten state by rotation of the screw 40 and heating of the plasticizing heater 58. After the shaping material generated by melting the thermoplastic material is dispensed from the nozzle 61, the shaping material is cured due to a reduction in temperature.

It is desirable that the thermoplastic material is dispensed from the nozzle 61 in a state of being melted completely by being heated to a temperature equal to or higher than a glass transition point thereof. For example, it is desirable that the ABS resin has a glass transition point of about 120° C. and is about 200° C. at a time of being dispensed from the nozzle 61.

In the three-dimensional shaping device 100, for example, the following metal materials may be used as the main material instead of the thermoplastic materials described above. In this case, it is desirable that a component to be melted at the time of generating the shaping material is mixed into a powder material obtained by converting the following metal materials into a powder, and then the mixture is put into the plasticizing unit 30 as the raw material.

### Examples of Metal Material

A single metal of magnesium (Mg), iron (Fe), cobalt (Co) or chromium (Cr), aluminum (Al), titanium (Ti), copper (Cu), and nickel (Ni), or an alloy containing one or more of these metals

### Examples of Alloy

Maraging steel, stainless steel, cobalt chrome molybdenum, titanium alloy, nickel alloy, aluminum alloy, cobalt alloy, and cobalt chromium alloy

In the three-dimensional shaping device 100, the ceramic material may be used as the main material instead of the above-described metal material. Examples of the ceramic material may include an oxide ceramic such as silicon dioxide, titanium dioxide, aluminum oxide, and zirconium oxide, and a non-oxide ceramic such as aluminum nitride. When the metal material or the ceramic material described above is used as the main material, the shaping material disposed on the stage 300 may be cured by being irradiated with a laser or being sintered with hot air.

A powder material of the metal material or the ceramic material to be put into the material accommodating unit 20 as the raw material may be a mixed material obtained by mixing a plurality of types of powder of a single metal, powder of the alloy, and powder of the ceramic material. The powder material of the metal material or the ceramic material may be coated with, for example, a thermoplastic resin as exemplified above or another thermoplastic resin. In this case, the thermoplastic resin may be melted to attain fluidity in the plasticizing unit 30.

For example, the following solvents may be added to the powder material of the metal material or the ceramic material to be put into the material accommodating unit 20 as the raw material. As the solvent, one type or a combination of two or more types selected from the following may be used.

### Examples of Solvent

Water, (poly) alkylene glycol monoalkyl ethers such as ethylene glycol monomethyl ether, ethylene glycol monoethyl ether, propylene glycol monomethyl ether, and propylene glycol monoethyl ether, acetate esters such as ethyl acetate, n-propyl acetate, isopropyl acetate, n-butyl acetate, and iso-butyl acetate, aromatic hydrocarbons such as benzene, toluene, and xylene, ketones such as methyl ethyl ketone, acetone, methyl isobutyl ketone, ethyl-n-butyl ketone, diisopropyl ketone, and acetylacetone, alcohols such as ethanol, propanol, and butanol, tetraalkylammonium acetates, sulfoxide-based solvents such as dimethyl sulfoxide and diethyl sulfoxide, pyridine-based solvents such as pyridine, γ-picoline, and 2,6-lutidine, tetraalkylammonium acetates (such as tetrabutylammonium acetate), and ionic liquids such as butyl carbitol acetate

For example, the following binders may be added to the powder material of the metal material or the ceramic material to be put into the material accommodating unit 20 as the raw material.

### Examples of Binder

Acrylic resin, epoxy resin, silicone resin, cellulose-based resin or other synthetic resins, or polylactic acid (PLA), polyamide (PA), polyphenylene sulfide (PPS), polyetheretherketone (PEEK) or other thermoplastic resins

### F. Other Aspects

The present disclosure is not limited to the above-described embodiments, and can be implemented by various configurations without departing from the gist of the present disclosure. For example, the present disclosure can also be implemented by the following aspects. In order to solve a part or all of technical problems according to the present disclosure, or to achieve a part or all of effects according to the present disclosure, technical characteristics in the above-described embodiments corresponding to technical characteristics in each of aspects to be described below can be replaced or combined as appropriate. Further, the technical characteristics can be deleted as appropriate unless the technical characteristics are described as essential in the present specification.

(1) According to an aspect of the present disclosure, the three-dimensional shaping device is provided. The three-dimensional shaping device includes: a stage having a shaping surface on which a shaping material is to be stacked; a dispensing unit configured to dispense the shaping material toward a shaping region on the shaping surface; a position changing unit configured to change a relative position between the dispensing unit and the stage; a first heating unit configured such that a relative position between the first heating unit and the stage changes together with the dispensing unit, configured to cover the shaping region at a position facing the shaping surface when viewed along a stacking direction of the shaping material, and configured to heat the shaping material stacked in the shaping region; and a control unit configured to control the dispensing unit, the first heating unit, and the position changing unit to stack layers of the shaping material in the shaping region and to shape a three-dimensional shaped object. The control unit controls the first heating unit based on a facing distance indicating a distance between the stage and the first heating unit in the stacking direction when the three-dimensional shaped object is shaped.

According to such an aspect, the first heating unit can preferentially heat an upper layer while heating the entire three-dimensional shaped object. In addition, since the first heating unit is controlled based on the facing distance, a temperature of the three-dimensional shaped object can be appropriately controlled regardless of a degree of progress of stacking. Therefore, the shape of the three-dimensional shaped object can be prevented from collapsing, and the interlayer adhesion can be improved.

(2) In the aspect described above, the control unit may set a set temperature of the first heating unit to a first set temperature when the facing distance is a first distance, and may set the set temperature of the first heating unit to a second set temperature higher than the first set temperature when the facing distance is a second distance longer than the first distance. According to such an aspect, the temperature of the three-dimensional shaped object can be appropriately controlled by simple control regardless of the degree of progress of the stacking.

(3) In the aspect described above, the three-dimensional shaping device may include a second heating unit configured to heat the stage. The control unit may control the second heating unit when the three-dimensional shaped object is shaped. According to such an aspect, by controlling the second heating unit, the three-dimensional shaped object can also be heated from the stage side in the stacking direction, and the amount of heat supplied from the stage to the three-dimensional shaped object can be controlled. Therefore, the temperature of the three-dimensional shaped object can be controlled more appropriately.

(4) In the aspect described above, the control unit may control the second heating unit based on the facing distance when the three-dimensional shaped object is shaped. According to such an aspect, the temperature of the three-dimensional shaped object can be controlled more appropriately compared to a case in which the second heating unit is controlled to have a constant output or a case in which the second heating unit is controlled to have a constant output regardless of the facing distance.

(5) In the aspect described above, the control unit may set a set temperature of the second heating unit to a third set temperature when the facing distance is a third distance, and may set the set temperature of the second heating unit to a fourth set temperature higher than the third set temperature when the facing distance is a fourth distance longer than the third distance. According to such an aspect, a temperature of the three-dimensional shaped object can be controlled more appropriately by the simple control regardless of the degree of progress of the stacking.

(6) In the aspect described above, the control unit may control the first heating unit based on the facing distance and a set temperature of the second heating unit when the three-dimensional shaped object is shaped. According to such an aspect, the first heating unit can be controlled in consideration of the influence of heat supplied from the second heating unit to the three-dimensional shaped object via the stage without providing a sensor that measures the temperature of the stage or a temperature of the layer. Therefore, the temperature of the three-dimensional shaped object can be more precisely controlled with a simple configuration.

(7) In the aspect described above, the three-dimensional shaping device may include a first sensor configured to measure a temperature of the stage. The control unit may control the first heating unit based on the facing distance and a measurement value of the first sensor when the three-dimensional shaped object is shaped. According to such an aspect, the first heating unit can be controlled in consideration of the influence of the heat supplied from the stage to the three-dimensional shaped object based on the measurement value of the first sensor. Therefore, the temperature of the three-dimensional shaped object can be controlled more precisely.

(8) In the aspect described above, the three-dimensional shaping device may include a second sensor that measures a temperature of the layer, and the control unit may control the first heating unit based on the facing distance and a measurement value of the second sensor when the three-dimensional shaped object is shaped. According to such an aspect, the first heating unit can be controlled in consideration of the actual temperature of the layer measured by the second sensor. Therefore, the temperature of the three-dimensional shaped object can be controlled more precisely.

What is claimed is:

1. A three-dimensional shaping device comprising:
a stage having a shaping surface on which a shaping material is to be stacked;
a dispensing unit configured to dispense the shaping material toward a shaping region on the shaping surface;
a position changing unit configured to change a relative position between the dispensing unit and the stage;
a first heating unit configured such that a relative position between the first heating unit and the stage changes together with the dispensing unit, configured to cover the shaping region at a position facing the shaping surface when viewed along a stacking direction of the shaping material, and configured to heat the shaping material stacked in the shaping region; and
a control unit configured to control the dispensing unit, the first heating unit, and the position changing unit to stack layers of the shaping material in the shaping region and to shape a three-dimensional shaped object, wherein
the control unit controls the first heating unit based on a facing distance indicating a distance between the stage and the first heating unit in the stacking direction when the three-dimensional shaped object is shaped.

2. The three-dimensional shaping device according to claim 1, wherein
the control unit sets a set temperature of the first heating unit to a first set temperature when the facing distance is a first distance, and sets the set temperature of the first heating unit to a second set temperature higher than the first set temperature when the facing distance is a second distance longer than the first distance.

3. The three-dimensional shaping device according to claim 1, further comprising:
a second heating unit configured to heat the stage, wherein
the control unit controls the second heating unit when the three-dimensional shaped object is shaped.

4. The three-dimensional shaping device according to claim 3, wherein
the control unit controls the second heating unit based on the facing distance when the three-dimensional shaped object is shaped.

5. The three-dimensional shaping device according to claim 4, wherein
the control unit sets a set temperature of the second heating unit to a third set temperature when the facing distance is a third distance, and sets the set temperature of the second heating unit to a fourth set temperature higher than the third set temperature when the facing distance is a fourth distance longer than the third distance.

6. The three-dimensional shaping device according to claim 3, wherein
the control unit controls the first heating unit based on the facing distance and a set temperature of the second heating unit when the three-dimensional shaped object is shaped.

7. The three-dimensional shaping device according to claim 1, further comprising:
a first sensor configured to measure a temperature of the stage, wherein
the control unit controls the first heating unit based on the facing distance and a measurement value of the first sensor when the three-dimensional shaped object is shaped.

8. The three-dimensional shaping device according to claim 1, further comprising:
a second sensor configured to measure a temperature of the layer, wherein
the control unit controls the first heating unit based on the facing distance and a measurement value of the second sensor when the three-dimensional shaped object is shaped.
